(19) United States
(12) Patent Application Publication
(10) Pub. No.: US 2023/0046139 A1
(43) Pub. Date: Feb. 16, 2023

(54) FERMENTED PLANT-BASED PROBIOTIC COMPOSITIONS AND PROCESSES OF PREPARING THE SAME

(71) Applicant: Compagnie Gervais Danone, Paris (FR)

(72) Inventors: Juan José COLÁS FEIXAS, Barcelona (ES); Luc TERRAGNO, Palaiseau (FR)

(21) Appl. No.: 17/759,141

(22) PCT Filed: Jan. 22, 2021
(86) PCT No.: PCT/IB2021/000041

§ 371 Date: Jul. 20, 2022

Related U.S. Application Data
(60) Provisional application No. 62/964,808, filed on Jan. 23, 2020.

(51) Int. Cl. A23L 11/50; A23C 11/10; A23L 33/135

(52) U.S. Cl. CPC A23L 11/50; A23C 11/106; A23L 33/135

(57) ABSTRACT

The present invention relates to the preparation of fermented plant-based compositions.

### FIELD OF THE INVENTION

The present invention relates to plant-based compositions comprising heterofermentative bifidobacteria and/or heterofermentative lactic acid bacteria in combination with homofermentative lactic acid bacteria, and processes of preparing said compositions having improved taste characteristics.

### STATE OF THE ART

There is increased interest in plant-based diets among mainstream consumers who consider themselves vegan, vegetarian or flexitarian. To cater to the dietary needs of such consumers a wide variety of plant-based analogues or alternatives to non-vegan food products are increasingly available. These include plant-based dairy alternatives such as milks, yogurts, cheeses & frozen desserts. The formulation of such products to provide a sensory and/or nutritional equivalent remains challenging.

This is especially the case in the formulation of “probiotic” food products which are also increasingly popular with consumers. According to a definition approved by a joint Food and Agriculture Organization of the United Nations/World Health Organization (FAO/WHO) expert Consultation on Health and Nutritional properties of powder milk with live lactic acid bacteria in 2001, probiotics are “live microorganisms which when administered in adequate amounts confer a health benefit on the host”. Probiotic bacteria have been described among species belonging to the genera Lactobacillus, Bifidobacterium, Streptococcus and Lactococcus, commonly used in the dairy industry. However, the addition of probiotic species, especially in the context of fermented food products can be challenging as they can introduce undesirable flavours or off-notes to products.

The use of probiotic species in the preparation of plant-based dairy alternatives is known in the art. U.S. Pat. No. 6,699,517, which is incorporated by reference herein, teaches the fermentation of vegetal bases using S. thermophilus CNCM I-1520 and various probiotic species (L. plantarum; L. casei; Bifidobacteria). The fermented products have improved (reduced) post-acidification and dairy-like organoleptic characteristics. The Inventors teach that the use of a combination of soy with cereal hydrolysates or almond milk provides a good fermentation medium for lactic acid bacteria.

Other disclosures concerning the use of probiotic species in the preparation of plant-based dairy alternatives are WO 2019/173290 (substrate comprising oat fibers).

### SUMMARY OF VARIOUS EMBODIMENTS

Plant-based compositions comprising heterofermentative bifidobacteria, lactic acid bacteria and/or combinations thereof and homofermentative lactic acid bacteria, along with processes for the preparation thereof are disclosed.

The Inventors found that heterofermentative bifidobacteria, lactic acid bacteria and/or combinations thereof, when used in combination with homofermentative lactic acid bacteria for the preparation of low-sugar plant-based fermented milk alternatives, provide a composition having relatively low levels of lactic acid and high levels of acetic acid, which cause acidic or vinegary flavor notes. Furthermore, the low production of lactic acid also resulted in long fermentation times.

There was thus a need to provide plant based yogurt alternatives with improved organoleptic properties (i.e. closer to that of the dairy equivalents), with healthy properties (i.e. with low sugar and containing probiotic bacteria) and that would be more appropriate for industrial fermentation (i.e. with shorter fermentation times).

Surprisingly, it was found by the Inventors that the use of a vegetal base for the fermentation substrate having a high quantity of low degree of polymerization (DP) sugars could reduce the undesirable effects and provide an improved taste.

In a first aspect, the present invention thus provides fermented plant-based compositions comprising heterofermentative bifidobacteria, lactic acid bacteria and/or combinations thereof (hereinafter also referred to as “compositions of the invention”) and homofermentative lactic acid bacteria. In a first embodiment, the fermented plant-based composition comprises heterofermentative bifidobacteria, lactic acid bacteria and/or combinations thereof wherein said composition of the invention is free from, or does not comprise, raffinose, stachyose or verbascose. In embodiments, said composition further comprises lactic and acetic acid in a ratio of 1.5 (lactic:acetic) or higher.

In a second aspect, the present invention provides a process for the preparation of fermented compositions of the invention. In a first embodiment, the present invention provides a process for the preparation of fermented compositions of the invention comprising fermenting a mixture comprising a vegetal base and heterofermentative bifidobacteria, lactic acid bacteria and/or combinations thereof in combination with homofermentative lactic acid bacteria to obtain a fermented plant-based composition, wherein said vegetal base does not comprise soy. In embodiments, said fermented compositions of the invention comprise lactic and acetic acid in a ratio of 1.5 (lactic:acetic) or higher.

### DETAILED DESCRIPTION OF VARIOUS EMBODIMENTS

As used herein, the term “ppm” shall be taken to mean “parts per million”. One gram in 1 liter is 1000 ppm and one thousandth of a gram (0.001 g) in 1 liter is one ppm.

As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

As used herein the term “plant-based” shall be taken to mean a composition or product which comprises plant or plant-derived matter but does not comprise animal or animal-derived matter including but not limited to dairy, egg, fish, shellfish, meat, dairy milk and insects.

As used herein the adjective “dairy” shall be taken to mean a composition or product comprises or consists of mammalian milk matter, i.e. the lacteal secretion obtainable by milking.

As used herein the terms “-free” or “free from” shall be taken to mean a composition or product which preferably does not contain a given substance but where trace amounts or contaminants thereof may be present.

As used herein, the term “DPn” refers to the degree of polymerization of sugars, where n is the number of monomeric units (i.e., glucose or dextrose units) in the saccharide, thus DPn reflects the composition of the carbohydrate. For example, DP1 is a monosaccharide; DP2 is a disaccharide; DP1+2 is the total of mono- and di-saccharides; DP3-10 is the total of DP3 to DP10 saccharides, DP3+ is the total of saccharides DP3 and greater. DP1 sugars include, but are not limited to, glucose, dextrose, fructose and galactose. DP2 sugars include, but are not limited to, sucrose, lactose, maltose and trehalose. DP3+ sugars include, but are not limited to, raffinose, stachyose, raffinose, stachyose or verbascose, fructo- and galacto-oligosaccharides and polydextrose. DPn is preferably expressed as a weight percent of a type of saccharides on a total carbohydrate dry weight basis. The DPn of a composition can be determined using high performance liquid chromatography (HPLC).

As used herein the term “added sugar” shall refer to sugars that are added during the production or processing of foods (e.g. plant matter processed to provide a vegetal base) as opposed to sugars naturally occurring in said foods. Added sugars include sugars (free, mono- and disaccharides), sugars from syrups and honey, and sugars from concentrated fruit or vegetable juices that are in excess of what would be expected from the same volume of 100 percent fruit or vegetable juice of the same type.

As used herein, the term “fermented plant-based” shall be taken to mean a product or composition that is the product of the acidifying fermentation of a plant-based composition by a starter culture of fermenting microorganisms, in particular bacteria, preferably lactic acid bacteria.

As used herein, the term “fermented dairy milk” shall be taken to mean a product or composition derived from dairy milk by the acidifying action of at least one lactic acid bacterium, such as a yogurt (e.g., a set, stirred or drink yogurt), or a fresh cheese such as a white cheese or a “petit-Suisse”. It can be also be a strained fermented milk such as a strained yoghurt (e.g., a concentrated or Greek-style yoghurt).

As used herein the terms plant-based alternative, analogue or substitute shall be taken to mean a plant-based food or beverage composition that is formulated to simulate the organoleptic and/or nutritional qualities of an equivalent non plant-based product. Accordingly, a “plant-based fermented milk alternative” shall be taken to mean a plant-based food or beverage composition that is formulated to simulate the organoleptic and/or nutritional qualities of fermented dairy milk. A “plant-based yogurt” shall be taken to mean a plant-based food or beverage composition that is formulated to simulate the organoleptic and/or nutritional qualities of fermented dairy yogurt.

The term “dairy yogurt” or “plant-based yogurt” as used herein shall be taken to mean fermented dairy or plant-based milk respectively obtained by the acidifying lactic fermentation of the bacteria Lactobacillus delbrueckii subsp. bulgaricus and Streptococcus thermophilus (also referred to as Streptococcus salivarius subsp. thermophilus), which must be viable in the finished product at a minimum CFU. In certain countries, regulations allow the addition of further lactic acid bacteria to yoghurt such as but not limited to strains of Bifidobacterium and/or Lactobacillus acidophilus and/or Lactobacillus casei. These additional lactic acid bacteria strains are intended to impart various properties to the finished product, such as that of providing organoleptic qualities, favoring equilibrium of intestinal flora or modulating the immune system.

As used herein, the term “strained composition” shall be taken to mean a fermented composition which has been subjected to a post-fermentation separation process.

As used herein, the term “spoonable” shall be taken to mean a solid or semi-solid that may be consumed by means of a spoon or other utensil.

As used herein, the term “fermentation” shall be taken to mean the metabolism of a substance by microorganisms, e.g. bacteria, yeasts, or other microorganisms.

As used herein, the term “heterofermentative” shall be taken to mean the obligate or facultative metabolism by microorganisms with both lactic and acetic acid as by-products.

As used herein, the term “homofermentative” shall be taken to mean the obligate or facultative metabolism by microorganisms with lactic but not acetic acid as by-product.

As used herein, the term “cfu” or “CFU” shall be taken to be an abbreviation of the term “colony forming unit”.

As used herein, the term “CNCM I-” followed by a 4 digit number shall be taken to refer to a strain deposited at the Collection Nationale de Cultures de Microorganismes (CNCM) 25 rue du Docteur Roux, Paris, France under the Budapest Treaty with an accession number corresponding to said 4 digit number, e.g. CNCM I-2494. As used herein, reference to a bacterial strain or species shall be taken to include functionally equivalent bacteria derived therefrom such as but not limited to mutants, variants or genetically transformed bacteria.

The present invention relates to plant-based compositions, and processes comprising heterofermentative bifidobacteria, lactic acid bacteria and/or combinations thereof.

### Plant-Based Compositions

In a first aspect, the present invention provides fermented plant-based compositions comprising heterofermentative bifidobacteria, lactic acid bacteria and/or combinations thereof.

In a first embodiment, the present invention provides compositions of the invention comprising i) a fermented vegetal base, ii) heterofermentative bifidobacteria, lactic acid bacteria and/or combinations thereof, iii) homofermentative lactic acid bacteria and iv) lactic and acetic acid, wherein said compositions do not comprise soy.

In an alternative embodiment, the present invention provides compositions of the invention comprising i) a fermented vegetal base, ii) heterofermentative bifidobacteria, lactic acid bacteria and/or combinations thereof, iii) homofermentative lactic acid bacteria and iv) lactic and acetic acid, wherein said compositions do not comprise raffinose, stachyose or verbascose.

In an alternative embodiment, the present invention provides compositions of the invention comprising i) a fermented vegetal base, ii) heterofermentative bifidobacteria iii) homofermentative lactic acid bacteria and iv) lactic and acetic acid, wherein said compositions do not comprise soy.

In an alternative embodiment, the present invention provides compositions of the invention comprising i) a fermented vegetal base, ii) heterofermentative bifidobacteria iii) homofermentative lactic acid bacteria and iv) lactic and acetic acid, wherein said compositions do not comprise raffinose, stachyose or verbascose.

Preferably, the fermented compositions of the invention, comprise free lactic and acetic acid, wherein the weight ratio of lactic to acetic acid is 1.5 or higher. Preferably the weight ratio of lactic to acetic acid is 1.6, 1.7, 1.8, 1.9, 2, 2.5 or higher. In embodiments, the weight ratio of lactic to acetic acid is between 1.5 and 4, more preferably between 1.5 and 3.

Preferably, the fermented compositions of the invention comprise above about 230 mg per 100 g by weight free lactic acid, more preferably above about 250 mg per 100 g by weight free lactic acid.

In embodiments, the composition comprises about 230 mg-500 mg per 100 g by weight free lactic acid, more preferably 250 mg-350 mg per 100 g.

Preferably, the fermented compositions of the invention comprise less than about 200 mg per 100 g by weight free acetic acid, more preferably less than about 150 mg per 100 g by weight free acetic acid. In embodiments, the composition comprises about 0.1 mg-200 mg per 100 g by weight free acetic acid, more preferably 0.1 mg-150 mg per 100 g.

In embodiments, the total sugar content by weight dry matter of the fermented compositions of the invention comprises at least about 50%, 55%, 60%, 65%, 70%, 75%, 80%, 85%, 90%, 95% or about 100% sugars having a degree of polymerization of DP1 to DP2.

In embodiments, the total sugar content by weight dry matter of the fermented compositions of the invention comprises less than about 50%, 45%, 40%, 35%, 30%, 25%, 20%, 15%, 10% or 5% of sugars having a degree of polymerization of DP3+.

In embodiments, the fermented compositions of the invention are free from, or do not comprise, added sugars. Preferably, the fermented compositions of the invention comprise less than 5 g/100 g sucrose, more preferably less than 3, 2, 1, 0.5 g/100 g sucrose. It is particularly preferred that the compositions of the invention are free from sucrose.

Preferably, the fermented compositions of the invention comprise less than about 10 g/100 g glucose, more preferably less than 5, 4, 3, 2, 1, 0.5 g/100 g.

In embodiments the fermented compositions of the invention are free from, or do not comprise, raffinose, stachyose or verbascose.

In embodiments, the plant-based compositions of the invention comprise at least 10⁵ cfu/g, more preferably at least 10⁶ cfu/g, such as at least 10⁷ cfu/g, e.g. at least 10⁸ cfu/g, such as at least 10⁹ cfu/g, e.g. at least 10¹⁰ cfu/g, such as at least 10¹¹ cfu/g of each of bacteria ii) and iii).

In embodiments, the plant-based compositions of the invention comprise at least 10⁵ cfu/g, more preferably at least 10⁶ cfu/g, such as at least 10⁷ cfu/g, e.g. at least 10⁸ cfu/g, of bacteria ii) for at least 40 days from preparation during storage at 10° C. In embodiments, the plant-based compositions of the invention comprise 10⁵ cfu/g-10⁸ cfu/g, more preferably 10⁶ cfu/g-10⁸ cfu/g, of bacteria ii) for at least 40 days from preparation during storage at 10° C.

In embodiments, the heterofermentative bacteria comprises Bifidobacteria, preferably selected from the group consisting of Bifidobacterium breve, Bifidobacterium bifidum, Bifidobacterium longum, Bifidobacterium infantis, and Bifidobacterium animalis.

In embodiments, the heterofermentative bacteria comprises Bifidobacterium animalis subsp. lactis and/or Bifidobacterium animalis subsp. animalis, preferably strain CNCM I-2494.

In embodiments, the heterofermentative bacteria comprises lactic acid bacteria selected from the group consisting of Lactobacillus brevis, Lactobacillus buchneri, Lactobacillus fermentum, Lactobacillus reuteri, Lactobacillus kefiri, Lactobacillus rhamnosus, Lactobacillus curvatus and/or combinations thereof.

The fermented plant-based compositions according to embodiments of the invention preferably comprise at least 10⁵, 10⁶, 10⁷, 10⁸ or 10⁹ CFU/g heterofermentative bifidobacteria, lactic acid bacteria and/or combinations thereof. In embodiments, the plant-based compositions of the invention comprise 10⁵ to 10¹² or 10⁶ to 10¹⁰ colony forming unit (CFU) heterofermentative bifidobacteria, lactic acid bacteria and/or combinations thereof per gram of composition. In a most preferred embodiment the plant-based compositions comprise between 1×10⁶ and 2×10⁸ cfu/g heterofermentative bifidobacteria, lactic acid bacteria and/or combinations thereof.

In embodiments of the invention the homofermentative lactic acid bacteria is selected from the group consisting of Lactobacillus, Streptococcus and/or combinations thereof, preferably L. Bulgaricus, S. thermophilus and/or combinations thereof. Optionally homofermentative lactic acid bacteria may comprise one or more strains of Lactococcus lactis, preferably L. lactis, L. cremoris and/or combinations thereof. In embodiments, the homofermentative lactic acid bacteria comprise one or more strains of L. Bulgaricus and one or more strains of S. thermophilus, and optionally one or more strains of Lactococcus lactis. In embodiments, the homofermentative lactic acid bacteria is selected from the group consisting of Lactobacillus delbrueckii subsp. bulgaricus CNCM I-1632 Lactobacillus delbrueckii subsp. bulgaricus CNCM I-1519, Streptococcus thermophilus CNCM I-1630 and Lactococcus lactis subsp. lactis CNCM I-1631.

In embodiments of the invention, the composition comprises a culture of L. delbrueckii subsp. bulgaricus CNCM I-1632, L. delbrueckii subsp. bulgaricus (“LB”) CNCM I-1519, S. thermophilus CNCM I-1630, L. lactis subsp. lactis CNCM I-1631 and B. animalis subsp. lactis CNCM I-2494

The fermented plant-based compositions according to embodiments of the invention preferably comprise at least 10⁵, 10⁶, 10⁷, 10⁸ or 10⁹ CFU/g homofermentative lactic acid bacteria. In embodiments, the plant-based compositions of the invention comprise 10⁵ to 10¹² or 10⁶ to 10¹⁰ colony forming unit (CFU) homofermentative lactic acid bacteria per gram of composition.

In specific embodiments the fermented plant-based compositions according to embodiments of the invention preferably comprises 1-50% w/w, more preferably 5%-25% w/w hydrolyzed oat syrup or slurry, 0%-5% w/w added sugar, 0%-10% w/w starch and remaining weight to 100% of water. Optionally the fermented plant-based compositions according to embodiments of the invention further comprises up to 5% w/w pulse protein; optionally up to 5% w/w acacia gum.

Preferably, the fermented plant-based composition is prepared by culture of a vegetal base at a suitable temperature with the microorganisms ii) and iii) to provide the required reduction in pH, preferably by culturing for less than or equal to 12, 10, 8, 7, 6, 5 or 4 hours.

In embodiments, the total sugar content by weight dry matter of the vegetal base of the invention comprises at least about 50%, 60%, 70%, 80%, 90%, 95% or are about 100% sugars having a degree of polymerization of DP1 to DP2.

In one embodiment, the vegetal base is an aqueous suspension comprising water and plant-matter selected from the group consisting of legumes, nuts, seeds, cereals and/or combination thereof. Particularly preferred is a base free from, or that does not comprise, added sugar, where the total carbohydrate content of the vegetal base is derived from plant-matter selected from the group consisting of legumes, nuts, seeds, cereals and/or combination thereof. In preferred embodiments, the plant-matter has been subjected to a step of hydrolysis (e.g. enzymatic hydrolysis) and thus the vegetal base comprises fully or partially hydrolyzed plant-matter such as fully or partially hydrolyzed cereal, in embodiments oat.

In specific embodiments, the vegetal base according to embodiments of the invention is a liquid cereal syrup or slurry, preferably comprising a fully or partially hydrolyzed cereal, in embodiments a liquid oat syrup or slurry comprising a fully or partially hydrolyzed oat, in embodiments fully or partially hydrolyzed oat flour.

In embodiments, the liquid cereal syrup comprises about 30-80%, preferably 40%-70% by total weight carbohydrates, in embodiments at least 40, 50 or 60 g/100 g. In embodiments, the carbohydrate sugar content (i.e. carbohydrate content excluding sugar alcohols, starches and dietary fibre) of the liquid cereal syrup comprises at least 80, 85 or 90% by weight dry matter maltose.

In specific embodiments, the vegetal base according to embodiments of the invention preferably comprises 1-50% w/w, more preferably 5%-25% w/w hydrolyzed oat syrup or slurry, 0%-5% w/w added sugar, 0%-10% w/w starch and remaining weight to 100% of water. Optionally, the vegetal base according to embodiments of the invention further comprises up to 5% w/w pulse protein; optionally up to 5% w/w acacia gum.

In some embodiments, the composition of the invention comprises a hydrolysed oat base, such as an oat syrup, in an amount of about 5% w/w.

In some embodiments, the composition of the invention comprises a vegetable base that is a mix of oat syrup, cane sugar, starch, pea protein, acacia gum sunflower oil, tricalcium phosphate and water.

In preferred embodiments, the vegetal base comprises comprise almond milk.

In embodiments, the plant-matter comprises legumes, and most preferably, pulse or pulses. In embodiments, the pulses are selected from the group consisting of split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy and/or lupin. In preferred embodiments, the pulses are pea and/or chickpea.

In embodiments, the nuts are selected from the group consisting of almonds, cashews, pecans, macadamias, hazelnuts, pistachio, walnuts or combinations thereof.

In embodiments, the seeds are selected from the group consisting of hemp, pumpkin, quinoa, sesame, tiger nut, flax, chia, sunflower, coconut or combinations thereof.

In embodiments, said cereals are selected from the group consisting of wheat, rye, spelt, barley, oat, millet, sorghum, rice, teff and combinations thereof.

Processes for the preparation of such suspensions are known in the art and typically comprise mechanical and/or enzymatic disruption of the plant-matter and hydration and/or combination with a solution, followed by mechanical separation of an aqueous fraction from starchy and/or fibrous matter, e.g., by decantering, centrifugation or filtration.

For example, the plant-matter may be milled, ground, soaked, dehulled, mixed with water, optionally enzymatic hydrolysed and/or homogenized etc. in order to produce a suitable aqueous composition.

In embodiments, the plant matter may be a seed or nut butter such as sunflower, sesame, soy, almond, cashew, hazelnut or peanut butter. Processes for the preparation of nut butters typically comprise wet or dry grinding roasted or unroasted nuts to a paste having a particle size suitable for the preparation of nut beverages.

In embodiments, the plant matter may be a hydrolyzed cereal suspension such as in the form of an oat milk or syrup.

In embodiments the vegetal base may comprise the hydrolyzed cereal suspension in an amount of 1-50%, 1-40%, 1-20% or 5-25%, by weight with reference to the total amount of base. In embodiments the vegetal base comprises up to about 30% (w/w) of said hydrolyzed cereal, e.g., up to about 10%, 15%, 20%, 25% (w/w). In one embodiment, the vegetal base comprise 1% to 30% (w/w) of said hydrolyzed cereal. In alternative embodiments, the vegetal base comprises 1% to 25% (w/w) of said hydrolyzed cereal. In further alternative embodiments, the vegetal base comprises 1% to 20% (w/w) of said hydrolyzed cereal. In additional embodiments, the vegetal base comprises 1% to 15% (w/w) of said hydrolyzed cereal. In further additional embodiments, the vegetal base comprises 1% to 10% (w/w) of said hydrolyzed cereal.

In embodiments the hydrolyzed cereal suspension may be a syrup having a dextrose equivalent (D.E.) value of 20-65, in embodiments 30-65.

Processes for the preparation of such cereal suspensions typically comprise mixing an oat material (such as rolled oats, milled oats, oat flour or oatmeal) with water and treated enzymatically by amylases to hydrolyze starch followed by removal of suspended matter.

Preferably, the vegetal base prior to fermentation comprises carbohydrate sugar content (by weight dry matter) of less than about 10 g/100 g glucose, more preferably less than 5, 4, 3, 2, 1, 0.5 g/100 g. In embodiments, the carbohydrate sugar content by weight dry matter comprises less than about 5 g/100 g sucrose, more preferably less than 3, 2, 1, 0.5 g/100 g sucrose. In embodiments, the carbohydrate sugar content by weight dry matter comprises more than about 80 g/100 g maltose, more preferably more than 85 or 90 g/100 g maltose.

In embodiments, the vegetal base prior to fermentation is free from, or does not comprise, galactose and/or fructose. Optionally, the vegetal base prior to fermentation comprises less than about 500 mg/100 g total sum raffinose, stachyose and verbascose, more preferably less than about 450 mg/100 g.

In particular embodiments, the vegetal base comprises a plant-based dairy analogue or dairy substitute beverage such as milk or cream, preferably a plant-based milk, such as nut, oat or coconut milk.

Processes for the preparation of said beverages typically comprise the incorporation of suitable plant-based matter (e.g. oat syrup, nut butter) with water and other ingredients such as emulsifiers, stabilizing and flavoring agents. In particular embodiments, other ingredients may include one or more hydrocolloids (e.g., gellan gum, guar gum, locust bean gum, and xanthan gum), one or more salts (e.g., sea salt (e.g., sodium chloride), a potassium phosphate (e.g., monopotassium phosphate (KH₂PO₄), dipotassium phosphate (K₂HPO₄), tripotassium phosphate (K₃PO₄) etc.), a sodium phosphate (e.g., disodium phosphate (Na₂HPO₄)), a calcium phosphate (e.g., tricalcium phosphate Ca₃(PO₄)₂), and/or any other suitable emulsifying, flavoring, stabilizing, and/or buffering agent or combination of agents), and lecithin. Other ingredients may also include nutritional supplements such as vitamin A, vitamin B2, vitamin B12, vitamin D, vitamin E, zinc, fiber, protein, calcium, potassium, phosphorus, fatty acids, (e.g., omega 3, omega 6, etc.).

In one embodiment, it is preferred that the vegetal base does not contain animal, soy, gluten, dairy matter and/or combinations thereof.

In one embodiment, the vegetal base may be enriched or fortified with further components or nutrients such as but not limited to vitamins, minerals, trace elements or other micronutrients.

Preferably, the compositions of the invention comprise a protein content of at least about 2.5%, more preferably at least about 3% or 3.5%, most preferably 4%-5% (w/w).

Preferably, the composition has a pH equal to or lower than 5, 4.9, 4.8, 4.7 or most preferably equal to or lower than 4.6. In embodiments, the composition has a pH preferably between about 4 and about 4.8, and more preferably between about 4.5 and about 4.8.

Preferably, the compositions of the invention has a viscosity lower than 200 mPa·s, more preferably lower than 100 mPa·s and most preferably lower that 60 mPa·s, at 10° C., at a shear rate of 64 s−1. In other embodiments, the composition has a viscosity range of 1 to 200 mPa·s, 1 to 100 mPa·s, or 1 to 60 mPa·s, at 10° C., at a shear rate of 64 s−1. In other embodiments, the composition has a viscosity range of 10 to 200 mPa·s, 10 to 100 mPa·s, or 10 to 60 mPa·s, at 10° C., at a shear rate of 64 s−1. In other embodiments, the composition has a viscosity range of 30 to 200 mPa·s, 30 to 100 mPa·s, or 30 to 60 mPa·s, at 10° C., at a shear rate of 64 s−1.

The fermented plant-based composition according to embodiments of the invention is preferably a food product, more preferably a plant-based fermented milk alternative. In embodiments, said composition is an alternative of a product selected from the group comprising yogurt, set yogurt, stirred yogurt, pourable yogurt, yogurt drink, frozen yogurt, kefir, buttermilk, quark, sour cream, fresh cheese and cheese. In one embodiment, the composition is a drinkable composition, more preferably a plant-based alternative of a fermented milk drink such as but not limited to a yogurt drink, kefir etc. In an alternative embodiment, the composition is a composition that is spoonable, such as a plant-based alternative of a set or stirred yogurt or equivalent thereof.

In one embodiment, the fermented plant-based composition is a strained fermented plant-based composition.

Preferably, the fermented plant-based composition according to embodiments of the invention, may be stored, transported and/or distributed at a temperature of from 1° C. to 10° C. for at least about 30 days, at least about 60 days or at least about 90 days from packaging and remain suitable for consumption.

Preferably, the composition is a packaged product that comprises at least 10⁶, more preferably at least 10⁷ and most preferably at least 10⁸ colony forming unit (CFU) heterofermentative bifidobacteria, lactic acid bacteria and/or combinations thereof per gram (g) of composition subsequent to storage, transport and/or distribution at a temperature of from 1° C. to 10° C. for at least about 30 days, at least about 60 days or at least about 90 days from packaging.

In embodiments, the heterofermentative bacteria comprises Bifidobacteria, preferably selected from the group consisting of Bifidobacterium breve, Bifidobacterium bifidum, Bifidobacterium longum, Bifidobacterium infantis, Bifidobacterium animalis. In embodiments the heterofermentative bacteria comprises Bifidobacterium animalis subsp. lactis and/or Bifidobacterium animalis subsp. animalis, preferably strain CNCM I-2494.

In embodiments, the heterofermentative bacteria comprises lactic acid bacteria selected from the group consisting of Lactobacillus brevis, Lactobacillus buchneri, Lactobacillus fermentum, Lactobacillus reuteri, Lactobacillus kefiri, Lactobacillus rhamnosus, Lactobacillus curvatus and/or combinations thereof.

In other embodiments, the composition is a packaged product that comprises 10⁵ to 10¹² or 10⁶ to 10¹⁰ colony forming unit (CFU) heterofermentative bifidobacteria, lactic acid bacteria and/or combinations thereof per gram (g) of composition subsequent to storage, transport and/or distribution at a temperature of from 1° C. to 10° C. for at least about 30 days, at least about 60 days or at least about 90 days from packaging.

In other embodiments, the composition of the invention further comprises an intermediate preparation hereinafter also referred to as “products of the invention”. They are typically used to modify the taste, mouthfeel and/or texture of plant-based fermented milk alternatives. They can used also to introduce some additives such as nutrients. They typically comprise sweetening agents, flavors, color modifiers, cereals and/or fruit. Intermediate fruit preparations are for example slurries or fruit preparations. Flavors include for example fruit flavors, vanilla flavors, caramel flavors, coffee flavors, chocolate flavors. Fruit preparations typically comprise fruits, as used herein the term “fruit” refers to any fruit form, including for example full fruits, pieces, purees, concentrates, juices etc.

The intermediate preparation or slurry typically comprises a stabilizing agent, having at least one stabilizer. The stabilizing agent can comprise at least two stabilizers. Such stabilizers are known to the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, a guar, a xanthan, a carrageenan, a locust bean gum, or a mixture thereof. The amount of stabilizing system is typically from 0.5 to 5% by weight.

The intermediate preparation can typically comprise organoleptic modifiers. Such ingredients are known by the one skilled in the art.

The organoleptic modifiers can be for example sweetening agents different from sugar, coloring agents, cereals and/or cereal extracts.

Examples of sweetening agents are ingredients referred to as High Intensity Sweeteners, such as sucralose, acesulfamK, aspartame, saccharine.

Examples of fruits include for example strawberry, peach, apricot, mango, prune, apple, pear, raspberry, blueberry, blackberry, passion, cherry, and mixtures or associations thereof, such as peach-passion.

The fruits can be for example provided as:
frozen fruit cubes, for example 10 mm fruit cubes, for example Individual Quick Frozen fruit cubes, for example strawberry, peach, apricot, mango, apple, pear fruit cubes or mixtures thereof,
Aseptic fruit cubes, for example 10 mm fruit cubes, for example strawberry, peach, apricot, mango, apple or pear fruit cubes or mixtures thereof,
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,
single aseptic fruit purees, for example strawberry, raspberry, peach, apricot, blueberry or apple single aseptic fruit purees or mixture thereof,
frozen whole fruits, for example Individual Quick Frozen whole fruits, for example blueberry, raspberry or blackberry frozen whole fruits, or mixtures thereof,
mixtures thereof.

The ingredients and/or components of the intermediate preparation and the amounts thereof can be typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

A fruit preparation can for example comprise fruit in an amount of from 30% to 80% by weight, for example from 50 to 70% by weight.

The intermediate preparation can comprise water. It is mentioned that a part of the water can come from ingredients used to prepare the fruit preparation, for example from fruits or fruit extracts or from a phosphoric acid solution.

The fruit preparation can comprise pH modification agents such as citric acid. The fruit preparation can have a pH of from 2.5 to 5, preferably of from 2.8 to 4.2.

Typically, a fruit or cereal preparation can be added in an amount of 5-35%, in particular in an amount of 5-20%, 5-10% or 10-15% by weight with reference to the total amount of product. In embodiments, the product of the invention comprises up to about 30% (w/w) of said intermediate preparation, e.g., up to about 5%, 6%, 7%, 8%, 9%, 10%, 11%, 12%, 13%, 14%, 15%, 16%, 17%, 18%, 19%, 20%, 21%, 22%, 23%, 24% or 25% (w/w). In one embodiment, the product according to embodiments of the invention comprise 1% to 30% (w/w) of said intermediate preparation. In alternative embodiments, the product comprises 1% to 25% (w/w) of said intermediate preparation. In further alternative embodiments, the product comprises 1% to 20% (w/w) of said intermediate preparation. In additional embodiments, the product comprises 1% to 15% (w/w) of said intermediate preparation. In further additional embodiments, the product comprises 1% to 10% (w/w) of said intermediate preparation. In some embodiments, the composition of the invention comprises a fruit preparation that is a mix of mango puree, mango cubes and flax seeds, said fruit preparation being preferably at an incorporation dose of about 15% in the composition.

In some embodiments, the composition of the invention comprises a fruit preparation that is a mix of prune and flax seeds, said fruit preparation being preferably at an incorporation dose of about 15% in the composition.

In some embodiments, the composition of the invention comprises a cereal preparation that is a mix of oat groats, oat flakes and wheat bran, said cereal preparation being preferably at an incorporation dose of about 10% in the composition.

Preferably, the composition or product, according to embodiments of the invention is provided in a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g or 500 g or about 1 oz, 2 oz, 3 oz, 4 oz, 5 oz, 6 oz or 12 oz product by weight.

In other embodiments, the composition or product is provided in a sealed or sealable container containing about 50 g to 500 g, 60 g to 500 g, 70 g to 500 g, 75 g to 500 g, 80 g to 500 g, 85 g to 500 g, 90 g to 500 g, 95 g to 500 g, 100 g to 500 g, 105 g to 500 g, 110 g to 500 g, 115 g to 500 g, 120 g to 500 g, 125 g to 500 g, 130 g to 500 g, 135 g to 500 g, 140 g to 500 g, 145 g to 500 g, 150 g to 500 g, 200 g to 500 g, 300 g to 500 g, 320 g to 500 g or 500 g product by weight. In other embodiments, the composition is provided in a sealed or sealable container containing about 1 oz to 12 oz, 2 oz to 12 oz, 3 oz to 12 oz, 4 oz to 12 oz, 5 oz to 12 oz, 6 oz to 12 oz or 12 oz product by weight.

In some specific embodiments, the composition of the invention is a fermented plant-based composition comprising:
a fermented vegetal base comprising a hydrolyzed oat syrup, preferably in an amount of 5%-25%, more preferably about 5%,
heterofermentative bifidobacteria preferably comprising B. lactis, and
homofermentative lactic acid bacteria,

optionally further comprising a non-fermented a fruit or cereal preparation.

In some specific embodiments, the composition of the invention is a fermented plant-based composition comprising:
a fermented vegetal base comprising a hydrolyzed oat syrup, preferably in an amount of 5%-25%, more preferably about 5%,
heterofermentative bifidobacteria comprising B. lactis CNCM I-2494, and
homofermentative lactic acid bacteria,

optionally further comprising a non-fermented a fruit or cereal preparation.

In some specific embodiments, the composition of the invention is a fermented plant-based composition comprising:
a fermented vegetal base comprising a hydrolyzed oat syrup, preferably in an amount of 5%-25%, more preferably about 5%,
heterofermentative bifidobacteria comprising B. lactis CNCM I-2494, and
homofermentative lactic acid bacteria comprising L. bulgaricus, S. thermophilus and/or L. lactis,

optionally further comprising a non-fermented a fruit or cereal preparation.

In some specific embodiments, the composition of the invention is a fermented plant-based composition comprising:
a fermented vegetal base comprising a hydrolyzed oat syrup, preferably in an amount of 5%-25%, more preferably about 5%,
heterofermentative bifidobacteria comprising B. lactis CNCM I-2494, and
homofermentative lactic acid bacteria comprising Lactobacillus bulgaricus CNCM I-1632, Lactobacillus bulgaricus CNCM I-1519, Streptococcus thermophilus CNCM I-1630, and Lactococcus lactis CNCM I-1631,
   optionally further comprising a non-fermented a fruit or cereal preparation.

### Processes for the Preparation of Fermented Plant-Based Compositions

In a second aspect, the present invention provides processes for the preparation of fermented plant-based compositions of the invention comprising inoculating a vegetal base that does not comprise soy with heterofermentative bifidobacteria, lactic acid bacteria and/or combinations thereof and homofermentative lactic acid bacteria and fermenting.

In a first embodiment, the present invention provides a process for the preparation of a fermented plant-based composition comprising fermenting a vegetal base that does not comprise soy by means of heterofermentative bifidobacteria, lactic acid bacteria and/or combinations thereof and homofermentative lactic acid bacteria to obtain a fermented plant-based composition comprising lactic and acetic acid in a ratio of 1.5 (lactic:acetic) or higher.

In an alternative embodiment, the present invention provides the use of homofermentative lactic acid bacteria in the preparation of a fermented plant-based composition comprising lactic and acetic acid in a ratio of 1.5 (lactic:acetic) or higher.

It is preferred that, in embodiments of processes or uses of the invention, said fermented plant-based composition comprises at least 10⁶, 10⁷, 10⁸ or 10⁹ CFU/g heterofermentative bifidobacteria, lactic acid bacteria and/or combinations thereof.

It is particularly preferred that, in embodiments of processes or uses of the invention, said bacterial strains are in the form of an inoculum or mixture thereof as described according to the present invention.

The embodiments of processes or uses of the invention may be carried out as a process comprising the following steps:

a) providing a mixture comprising:
i) vegetal base
ii) heterofermentative bifidobacteria, lactic acid bacteria and/or combinations thereof
iii) homofermentative lactic acid bacteria
   b) fermenting the mixture to provide a fermented plant-based composition wherein said vegetal base does not comprise soy or alternatively in embodiments the total sugar content by weight dry matter of the vegetal base of the invention comprise at least about 50%, 60%, 70%, 80%, 90%, 95% or are about 100% sugars having a degree of polymerization of DP1 to DP2.

### a) Mixtures

i) Vegetal Base

Vegetal bases as described above may be used in the processes of the invention.

In embodiments, the sugar content by weight dry matter of the vegetal base of the invention comprises at least about 50%, 60%, 70%, 80%, 90%, 95% or are about 100% sugars having a degree of polymerization of DP1 to DP2.

In one embodiment, the vegetal base is an aqueous suspension comprising water and plant-matter (as described above) selected from the group consisting of legumes, nuts, seeds, cereals and/or combination thereof. Particularly preferred is a base free from, or that does not comprise, added sugar, where the total carbohydrate content of the vegetal base is derived from plant-matter selected from the group consisting of legumes, nuts, seeds, cereals and/or combination thereof. In preferred embodiments the plant-matter has been subjected to a step of hydrolysis (e.g. enzymatic hydrolysis) and thus the vegetal base is free—from fully or partially hydrolysed plant-matter such as fully or partially hydrolyzed cereal. In preferred embodiments the vegetal base comprises almond milk.

Preferably, the vegetal base prior to fermentation comprises less than 5 mg/100 g glucose, more preferably less than 3 mg/100 g and most preferably less than 2 mg/100 g. Preferably, the vegetal base prior to fermentation comprise less than about 650 mg/100 g sucrose, more preferably less than 550 mg/100 g and most preferably less than 500 mg/100 g. In embodiments, the vegetal base prior to fermentation are free from or do not comprise galactose and fructose. Optionally, the vegetal base comprises less than 500 mg/100 g total sum raffinose, stachyose and verbascose; more preferably less than 450 mg/100 g.

Preferably, the vegetal base prior to fermentation comprises 0.1-5 mg/100 g glucose, more preferably 0.1-3 mg/100 g and most preferably 0.1-2 mg/100 g. Preferably, the vegetal base prior to fermentation comprises less than about 650 mg/100 g sucrose, more preferably 0.1-550 mg/100 g and most preferably 0.1-500 mg/100 g.

Preferably, fermented plant-based compositions are prepared using a vegetal base that has been subjected to heat treatment at least equivalent to pasteurization. Preferably, the heat treatment is carried out prior to the preparation of the composition.

In specific embodiments, the fermented plant-based compositions according to embodiments of the invention preferably comprise 5%-25% w/w hydrolyzed oat syrup or slurry, 0%-5% w/w added sugar, 0%-10% w/w starch and remaining weight to 100% of water. Optionally, the fermented plant-based compositions according to embodiments of the invention further comprise up to 5% w/w pulse protein; optionally up to 5% w/w acacia gum.

ii) Bacteria

In embodiments, the mixtures comprise at least 10⁵ cfu/g, more preferably at least 10⁶ cfu/g, such as at least 10⁷ cfu/g of each bacterial strain of ii) heterofermentative bifidobacteria, lactic acid bacteria and/or combinations thereof & iii) homofermentative lactic acid bacteria, e.g. between about 1×10⁵ and 1×10⁸ cfu/g.

In embodiments the heterofermentative bacteria comprises Bifidobacteria, preferably selected from the group consisting of Bifidobacterium breve, Bifidobacterium bifidum, Bifidobacterium longum, Bifidobacterium infantis, Bifidobacterium animalis. In embodiments, the heterofermentative bacteria comprises Bifidobacterium animalis subsp. lactis and/or Bifidobacterium animalis subsp. animalis, preferably strain CNCM I-2494.

In embodiments, the heterofermentative bacteria comprises lactic acid bacteria selected from the group consisting of Lactobacillus brevis, Lactobacillus buchneri, Lactobacillus fermentum, Lactobacillus reuteri, Lactobacillus kefiri, Lactobacillus rhamnosus, Lactobacillus curvatus and/or combinations thereof.

The fermented plant-based compositions according to embodiments of the invention preferably comprise at least 10⁵, 10⁶, 10⁷, 10⁸ or 10⁹ CFU/g heterofermentative bifidobacteria, lactic acid bacteria and/or combinations thereof. In embodiments, the plant-based compositions of the invention comprise 10⁵ to 10¹² or 10⁶ to 10¹⁰ colony forming unit (CFU) heterofermentative bifidobacteria, lactic acid bacteria and/or combinations thereof per gram of composition. In a most preferred embodiment, the plant-based compositions comprise between 1×10⁶ and 2×10⁸ cfu/g heterofermentative bifidobacteria, lactic acid bacteria and/or combinations thereof.

In embodiments of the invention, the homofermentative lactic acid bacteria is selected from the group consisting of Lactobacillus, Streptococcus and/or combinations thereof, preferably L. Bulgaricus, S. thermophilus and/or combinations thereof.

Optionally homofermentative lactic acid bacteria may comprise one or more strains of Lactococcus lactis, preferably L. lactis, L. cremoris and/or combinations thereof.

The fermented plant-based compositions according to embodiments of the invention preferably comprise at least 10⁵, 10⁶, 10⁷, 10⁸ or 10⁹ CFU/g homofermentative lactic acid bacteria. In embodiments, the plant-based compositions of the invention comprise 10⁵ to 10¹² or 10⁶ to 10¹⁰ colony forming unit (CFU) homofermentative lactic acid bacteria per gram of composition.

According to embodiments of the process of the invention, the homofermentative lactic acid bacteria comprises at least one, two, three or more strains of homofermentative lactic acid bacteria.

Preferably, said homofermentative lactic acid bacteria are characterized in that they are capable of fermenting the vegetal base in its unfermented state to the pH of the composition (preferably equal to or lower than 5, 4.9, 4.8, 4.7 or most preferably equal to or lower than 4.6) by culturing at a temperature of 35° C.-41° C. for less than or equal to 8 hours at an inoculation rate sufficient to provide the final CFU of said homofermentative bacteria in said product.

The selection of suitable lactic acid bacteria strains is within the scope of the skilled person and is typically a thermophilic lactic acid bacteria. Examples of lactic acid bacteria that can be used include but are not limited to Lactobacilli (for example Lactobacillus acidophilus, Lactobacillus buchneri, Lactobacillus casei, Lactobacillus plantarum, Lactobacillus reuteri, Lactobacillus johnsonii, Lactobacillus helveticus, Lactobacillus brevis, Lactobacillus rhamnosus); Lactococci (for example Lactococcus lactis, typically Lactococcus lactis subsp. lactis or Lactococcus lactis subsp. cremoris). Typically, a mixture or association of a plurality of strains of lactic acid bacteria may be used, typically a mixture or association of Lactobacillus and Streptococcus. For the preparation of yogurt this typically includes Lactobacillus bulgaricus (also referred to as Lactobacillus delbrueckii subsp. bulgaricus) and Streptococcus thermophilus, optionally with additional microorganisms such as but not limited to probiotic species or other species that may provide desirable organoleptic or other qualities to the composition, e.g. Lactococcus lactis.

Accordingly, in one embodiment, the mixture comprises at least one strain selected from the group consisting of Lactobacillus bulgaricus, Streptococcus thermophilus and/or combinations thereof and optionally one or more strains of Lactococcus lactis.

In embodiments the mixture comprises one or more strains of L. Bulgaricus and one or more strains of S. thermophilus, and optionally one or more strains of Lactococcus lactis. In embodiments the mixture comprises one or more strains selected from the group consisting of Lactobacillus delbrueckii subsp. bulgaricus CNCM I-1632 Lactobacillus delbrueckii subsp. bulgaricus CNCM I-1519, Streptococcus thermophilus CNCM I-1630 and Lactococcus lactis subsp. lactis CNCM I-1631. For example in one embodiment the mixture comprises all of the strains Lactobacillus delbrueckii subsp. bulgaricus CNCM I-1632 Lactobacillus delbrueckii subsp. bulgaricus CNCM I-1519, Streptococcus thermophilus CNCM I-1630 and Lactococcus lactis subsp. lactis CNCM I-1631.

b) Fermentation

Fermentation of the mixture is carried out by incubating the mixture at a temperature suitable for the metabolization of the vegetal base by the bacteria to provide a reduction in pH. Suitable temperatures for such fermentation are typically about 36° C. to about 45° C. and the temperature is maintained for an incubation time sufficient to provide the desired reduction in pH.

Preferably, the fermented plant-based composition is prepared by culture of the mixture to provide a reduction in pH, preferably to a pH equal to or lower than 5, 4.9, 4.8, 4.7 or 4.6. In embodiments, the fermentation is carried out to a pH preferably between about 4 and about 4.8, and more preferably between about 4.5 and about 4.8. The pH can be adjusted by controlling the fermentation by the microorganism and stopping it when appropriate, for example by cooling.

Preferably, the fermented plant-based composition is prepared by culture of the mixture to provide a composition comprising free lactic and acetic acid, wherein the weight ratio of lactic to acetic acid is 1.5 or higher. Preferably, the weight ratio of lactic to acetic acid is 1.6, 1.7, 1.8, 1.9, 2, 2.5 or higher. In embodiments the weight ratio of lactic to acetic acid is between 1.5 and 4, more preferably between 1.5 and 3.

Preferably, the fermented plant-based composition is prepared by culture of the mixture to provide a composition substantially free from, or that does not comprise sucrose.

Preferably, the fermented plant-based composition is prepared by culture of the mixture at a suitable temperature with the microorganisms to provide the required reduction in pH, preferably by culturing for less than or equal to 12, 10, 8, 7 or 6 hours.

It is preferred that in embodiments of processes or uses of the invention said fermentation is carried out at a temperature of less than about 45° C. or 42° C., particularly preferred is a temperature of 35° C.-42° C., more preferably 39° C.-41° C. For the preparation of a fermented plant-based composition the temperature at the start of fermentation is typically about 36° C. to about 43° C., in particular about 37° C. to about 40° C., the temperature at the end of fermentation is typically about 37° C. to about 44° C., in particular about 38° C. to about 42° C.

Subsequent to the fermentation, the fermented plant-based composition is preferably cooled. Optionally, a stage of intermediate cooling may be performed to provide a pre-cooled fermented composition having a temperature of between about 22° C. and about 4° C. Typically the intermediate cooling time is about 1 hour to about 4 hours, in particular about 1 hour 30 minutes to about 2 hours. The pre-cooled fermented plant-based composition is typically stored for up to 40 hours or less.

Preferably, a stage of final cooling of the fermented plant-based composition is performed such that the temperature at the start of the final cooling is less than about 22° C. and the temperature at the end of the final cooling is about 4° C. to about 10° C. The cooled composition may then be stored, transported and/or distributed at a temperature from about 1° C. to about 10° C. for at least about 30 days, at least about 60 days or at least about 90 days.

According to a further embodiment, the process for the preparation of a fermented plant-based composition as defined above optionally comprises a stage of stirring at a pressure of at least 20 bars, or performing a dynamic smoothing, to obtain a composition having the desired viscosity, typically a viscosity of up to 20 mPa·s. Stirring or dynamic smoothing operations provide some shear to composition that typically allow a viscosity drop. Such operations are known by the one skilled in the art, and can be operated with conventional appropriate equipment. This stage is typically performed at cold temperature, for example at a temperature of form 1° C. to 20° C. Without intending to be bound to any theory, it is believed that applying some shear at cold temperature, typically by stirring at high pressure or by performing a dynamic smoothing, can lead to a fluid gel formation within the composition, that provides improved stability even at a low viscosity of up to 20 mPa·s.

Alternatively, according to a further embodiment, the process for the preparation of a fermented plant-based composition as defined above optionally comprises a stage of straining to provide a “strained fermented plant-based composition”. In this step an aqueous composition is separated from the curd resulting from the protein coagulation due to acidification during fermentation. Thus one obtains:
a fermented plant-based composition, typically comprising the proteins coagulum, referred to as a strained fermented plant-based composition, and
an aqueous by-product

Such separation steps are known by the one skilled in art, for example in processes of making “greek yogurts”. The separation can for example be carried out by reverse osmosis, ultrafiltration, or centrifugal separation. The separation step can be performed for example at a temperature of from 30° C. to 45° C.

According to a further embodiment, the process for the preparation of a fermented plant-based product as defined above optionally comprises c) a stage of addition of an intermediate preparation prior or, more preferably subsequent to fermentation, said intermediate preparation typically comprising a preparation of fruits and/or cereals and/or additives such as flavorings and/or colourings.

Intermediate preparation are typically used to modify the taste, mouthfeel and/or texture of plant-based fermented milk alternatives. They can used also to introduce some additives such as nutrients. They typically comprise sweetening agents, flavors, color modifiers, cereals and/or fruit. Intermediate fruit preparations are for example slurries or fruit preparations. Flavors include for example fruit flavors, vanilla flavors, caramel flavors, coffee flavors, chocolate flavors.

Fruit preparations typically comprise fruits, as used herein the term “fruit” refers to any fruit form, including for example full fruits, pieces, purees, concentrates, juices etc.

The intermediate preparation or slurry typically comprises a stabilizing agent, having at least one stabilizer. The stabilizing agent can comprise at least two stabilizers. Such stabilizers are known to the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, an agar, a xanthan, a carrageenan, a locust bean gum, or a mixture thereof. The amount of stabilizing system is typically from 0.5 to 5% by weight.

The intermediate preparation can typically comprise organoleptic modifiers. Such ingredients are known by the one skilled in the art.

The organoleptic modifiers can be for example sweetening agents different from sugar, coloring agents, cereals and/or cereal extracts.

Examples of sweetening agents are ingredients referred to as High Intensity Sweeteners, such as sucralose, acesulfamK, aspartame, saccharine.

Examples of fruits include for example strawberry, peach, apricot, mango, apple, pear, raspberry, blueberry, blackberry, passion, cherry, and mixtures or associations thereof, such as peach-passion.

The fruits can be for example provided as:
frozen fruit cubes, for example 10 mm fruit cubes, for example Individual Quick Frozen fruit cubes, for example strawberry, peach, apricot, mango, apple, pear fruit cubes or mixtures thereof,
Aseptic fruit cubes, for example 10 mm fruit cubes, for example strawberry, peach, apricot, mango, apple or pear fruit cubes or mixtures thereof,
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,
single aseptic fruit purees, for example strawberry, raspberry, peach, apricot, blueberry or apple single aseptic fruit purees or mixture thereof,
frozen whole fruits, for example Individual Quick Frozen whole fruits, for example blueberry, raspberry or blackberry frozen whole fruits, or mixtures thereof,
mixtures thereof.

The ingredients and/or components of the intermediate preparation and the amounts thereof can be typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

A fruit preparation can for example comprise fruit in an amount of from 30% to 80% by weight, for example from 50 to 70% by weight.

The intermediate preparation can comprise water. It is mentioned that a part of the water can come from ingredients used to prepare the fruit preparation, for example from fruits or fruit extracts or from a phosphoric acid solution.

The fruit preparation can comprise pH modification agents such as citric acid. The fruit preparation can have a pH of from 2.5 to 5, preferably of from 2.8 to 4.2.

Typically a fruit preparation can be added in an amount of 5-35% by weight with reference to the total amount of product. In embodiments the product of the invention comprises up to about 30% (w/w) of said intermediate preparation, e.g., up to about 10%, 15%, 20%, 25% (w/w). In one embodiment, the product according to embodiments of the invention comprise 1% to 30% (w/w) of said intermediate preparation. In alternative embodiments, the product comprises 1% to 25% (w/w) of said intermediate preparation. In further alternative embodiments, the product comprises 1% to 20% (w/w) of said intermediate preparation. In additional embodiments, the product comprises 1% to 15% (w/w) of said intermediate preparation. In further additional embodiments, the product comprises 1% to 10% (w/w) of said intermediate preparation.

It is preferred that, in embodiments of processes of the invention, said fermented plant-based composition is stored at a temperature of from 1° C. to 10° C., preferably under refrigerated conditions for at least 24, 48 or 72 hours after packaging prior to consumption.

The product of the invention can typically be used as a plant-based fermented milk alternative as described above. The invention will be further illustrated by the following non-limiting Figures and Examples.

### EXAMPLES

### Materials & Methods

Organic acids were analyzed using High Performance Liquid Chromatography coupled with Spectrophotometric detection (in the UV field). HPLC-UV was performed using an Ultimate 3000 equipment (Thermofisher).
Prior to analysis, samples were homogenized, diluted with MilliQ water, filtrated (0.2 μm) and injected into the chromatographic system. Separation was carried out using a cation exchange column IC SEP ICE COREGEL 87H3—300×7.8 mm from Transgenomic (INTERCHIM). After separation, organic acids were detected by spectrophotometric detection.
Quantification was performed by calibration using standards solutions analyzed exactly in the same conditions.

### Example 1: High Acetic Acid Content in Plant-Based Probiotic Yogurt Alternative

### Culture 1:

A plant-based probiotic culture was provided in frozen form and defrosted for inoculation.

### The Culture Comprised:

Lactobacillus delbrueckii subsp. bulgaricus (“LB”) CNCM I-1632
Lactobacillus delbrueckii subsp. bulgaricus (“LB”) CNCM I-1519
Streptococcus thermophilus (“ST”) CNCM I-1630,
Lactococcus lactis subsp. lactis (“LC”) CNCM I-1631
Bifidobacterium animalis subsp. lactis (“BIF”) CNCM I-2494
Two fermented milk test products were prepared by inoculating cow milk (control) and soy milk (soy, water, antioxidant, sea salt) with the culture (0.08% volume) and incubating at 40° C. until a pH of 4.6 was reached. Fermentation was stopped by rapid cooling followed by storage at 4° C. overnight and then at 10° C. Acetic and lactic acid in the fermented products was measured as described above at 3 days of storage.
Fermentation was carried out in batches of 1.5 L (for pH testing) and concurrently in 125 mL yogurt pots (8 pots) for fermentation metabolite testing.
Results are given in Table 1.

TABLE 1

| | Acetic Acid | Lactic Acid |
|---|---|---|
| | mg/100 g | mg/100 g |
| Cow milk | 36 | 684 |
| Soy milk | 160 | 140 |

Surprisingly, it was found that fermentation of soy milk took extremely long (22 h28 to reach pH 4.6, pH 4.73 was reached at 11 h) and resulted in a product having a significantly higher amount of acetic acid. The culture produced about 5 times more acetic acid (≈160 mg/100 g vs ≈36 mg/100 g) and 5 times less lactic acid (≈140 mg/100 g vs ≈684 mg/100 g) in the soy milk matrix compared to a milk matrix.
The ratio of lactic:acetic acid in the control (cow milk) product was 19:1 (“19”), whereas in the soy product it was 0.88:1 (“0.88”).
Acetic acid contributes vinegary or sour notes to the final product which was detected by a tasting panel.
Neither acetic nor lactic acid were detected in the unfermented soy milk, as the B. lactis was the sole heterofermentative (acetic acid producing) strain it is assumed that the B. lactis is growing faster in soy than in cow milk.
Accordingly, it was determined that in order to provide an improved organoleptic experience for healthy (low sugar and containing probiotic bacteria) plant based yogurt alternatives that is closer to that of the dairy equivalent, there was a need for reducing the amount of acetic acid and to provide a higher lactic:acetic acid ratio in the fermented plant-based product containing heterofermentative bacteria to provide a less acidic vinegary tasting product.

### Example 2: Oat Yogurt Alternative Product Preparation

The soy milk base tested in Example 1 had about 50% DP1-DP2 sugars (about 100% sucrose) by weight total sugars content and 50% DP3-DP5 (about 22% raffinose, about 74% stachyose and about 4% verbascose).
It was decided to test an alternative plant-base comprising primarily non-sucrose DP1-DP2 sugars, as an alternative solution to the use of Culture 1. Accordingly, a hydrolyzed oat base (food-grade hydrolyzed oat flour) Natu-Oat syrup 35 (Meurens™) was selected which had about 100% DP1-DP2 sugars (about 93% maltose, 5% glucose and 2% sucrose) by weight total sugars (dry matter).
As lactic acid is the principle acidifying component during the fermentation, time to pH 4.7 was considered to be an indicator of the lactic acid content.
Fermented milk test products were prepared by inoculating oat base mixes (see Table 2) with the culture (0.1% volume) and incubating at 40° C. until a pH of 4.6 was reached. Fermentation was stopped by rapid cooling followed by storage at 4° C. overnight and then at 10° C.
Results are given in Table 2.

TABLE 2

| | Mix 1 | Mix 2 |
|---|---|---|
| | (% weight) | (% weight) |
| Natu-Oat syrup 35 | 15 | 15 |
| (Meurens ™) | | |
| Sugar | | 3 |
| Modified starch | 4 | 5.7 |
| Starch | | 1 |
| Pea Protein | 2 | |
| Acacia gum | 1.7 | 2 |
| Water | 77.3 | 73.3 |
| Fermentation time | 4 H 33 | 4 H 10 |
| pH after cooling | 4.76 | 4.67 |
| pH D + 1 | 4.45 | 4.35 |
| pH D + 40 | 4.31 | 4.18 |

As can be seen, the time to reach pH of about 4.7 was significantly faster than in soy base.
Without wishing to be bound by theory, it would appear that the presence of the larger sugars metabolized by the Bifidobacteria contributed to the continued production of a vinegary tasting product.

### Example 3: Fruit Oat Yogurt Alternative

An oat fermented “plain” yogurt alternative was prepared according to the teachings of Example 2. Test products were also prepared comprising a fruit and seed “slurry” or cereal preparation at 15% w/w final product (see below for further details: mango-flax; prune-flax; oat flakes) mixed into the plain product after fermentation.
At the end of storage (42 days 10° C.), it was surprisingly observed that Bifidobacteria survival was approximately 2 logs CFU count higher in products comprising a fruit preparation (Bifidobacteria count was maintained in the average range of log 6-7 with the addition of the preparation as compared to less than log 5 without). The improvement in Bifidobacteria survival was reconfirmed using 10% w/w of the oat flakes preparation.
Mango-flax preparation: Mango cubes and puree, dried flax seeds (47% w/w)
Prune-flax preparation: rehydrated prunes, dried flax seeds (63% w/w)
Oat flakes: dry oat flakes and groats, dry wheat bran (13% w/w)
The preparations also included sweetening, flavouring, colouring and thickening agents as well as calcium (less than 2% of each agents and mineral) as well as water to make up to 100% weight.

### Example 4

It was decided to validate the product of Example 2 using an alternative plant-base comprising primarily of non-sucrose DP1-DP2 sugars, to confirm the findings of Example 2.
Accordingly, a hydrolyzed oat base (food-grade hydrolyzed oat flour) Natu-Oat syrup 62 (Meurens™), was selected which had about 100% DP1-DP2 sugars (49.25% each maltose and glucose and 1.5% sucrose by weight total sugars (dry matter).
The oat base mix was prepared as shown in Table 3.

TABLE 3

| | Mix 3 |
|---|---|
| | (% weight) |
| Natu-Oat syrup 62 | 6 |
| (Meurens ™) | |
| Sugar | 4 |
| Tapioca flour | 2 |
| Oat flour | 1 |
| Fava Bean Protein | 5 |
| Acacia gum | 1 |
| Water | 79 |
| Rapeseed oil | 2 |

Fermented test products were prepared by inoculating the oat base mix with the culture 1 (0.1% volume) and incubating at 37° C. until a pH of 4.75 was reached. Fermentation was stopped by rapid cooling followed by storage at 4° C. and storage at 10° C.
During storage, good viability of the Bifidobacteria was maintained (day 3: 2.5×10⁸ CFU/g; day 15: 2×10⁸ CFU/g; day 35: 1.8×10⁸ CFU/g).

1. A process for the preparation of a fermented plant-based composition comprising
a) providing a mixture comprising:
i) vegetal base,
ii) heterofermentative bifidobacteria, lactic acid bacteria and/or combinations thereof, and
iii) homofermentative lactic acid bacteria, and
b) fermenting the mixture to provide a fermented plant-based composition wherein the total sugar content of the vegetal base by weight dry matter comprises at least about 50% sugars having a degree of polymerization of DP1 to DP2.

2. The process according to claim 1, further comprising c) incorporating a fruit or cereal preparation.

3. A plant-based composition comprising
i) vegetal base,
ii) at least at least 10⁵ cfu/g of heterofermentative bifidobacteria, lactic acid bacteria and/or combinations thereof, and
iii) homofermentative lactic acid bacteria wherein the total sugar content of the vegetal base by weight dry matter comprises at least about 50% sugars having a degree of polymerization of DP1 to DP2.

4. The composition of claim 3, wherein the composition or vegetal base does not comprise raffinose, stachyose or verbascose.

5. The composition of claim 3, wherein the composition or vegetal base does not comprise soy.

6. The composition of claim 3, wherein the composition or vegetal base comprises plant-matter selected from the group consisting of pulse, cereal, nut, seed and/or combinations thereof.

7. The composition of claim 3, wherein the composition or vegetal base comprises coconut, almond and/or fully or partially hydrolysed cereal.

8. The composition of claim 3, wherein the composition is a dairy-alternative.

9. A fermented plant-based composition comprising:
a fermented vegetal base comprising a hydrolyzed oat syrup in an amount of 5%-25%,
heterofermentative bifidobacteria, and
homofermentative lactic acid bacteria.

10. The composition of claim 9, further comprising a non-fermented a fruit or cereal preparation.

11. The process of claim 1, wherein the composition or vegetal base does not comprise raffinose, stachyose or verbascose.

12. The process of claim 1, wherein the composition or vegetal base does not comprise soy.

13. The process of claim 1, wherein the composition or vegetal base comprises plant-matter selected from the group consisting of pulse, cereal, nut, seed and/or combinations thereof.

14. The process of claim 1, wherein the composition or vegetal base comprises coconut, almond and/or fully or partially hydrolysed cereal.

15. The process of claim 1, wherein the composition is a dairy-alternative.
